(19) United States
(12) Patent Application Publication
(10) Pub. No.: US 2021/0042277 A1
(43) Pub. Date: Feb. 11, 2021

(54) SYSTEM FOR RESTRUCTURING ELECTRONIC DATA ELEMENTS WITHIN A MUTABLE HIERARCHICAL DATABASE

(71) Applicant: Bank of America Corporation, Charlotte, NC (US)

(72) Inventors: Brandon Sloane, Indian Land, SC (US); John Howard Kling, Cincinnati, OH (US)

(73) Assignee: Bank of America Corporation, Charlotte, NC (US)

(21) Appl. No.: 16/531,612

(22) Filed: Aug. 5, 2019

(51) Int. Cl. G06F 16/21; G06F 16/28; G06F 16/242

(52) U.S. Cl. CPC G06F 16/213; G06F 16/2423; G06F 16/282

(57) ABSTRACT

A system provides for restructuring electronic data elements within a mutable hierarchical database. In particular, the system may dynamically perform perspective-based restructuring the database depending on the status and/or identity of the user or computing system that is accessing the database. In this regard, the system may use an artificial intelligence and/or machine learning application to progressively modify relationships and/or attributes of data elements within the database to create multiple configurations or arrangements of database structures along certain perspectives and/or dimensions. Once the multiple configurations are generated, the system may allow the data structures to be dynamically adjusted based on the perspective or purpose for which the database is accessed.

### FIELD OF THE INVENTION

The present disclosure embraces a system for restructuring electronic data elements within a mutable hierarchical database.

### BACKGROUND

Data structures within conventional databases are typically rigidly fixed in the configuration specified at the time in which the databases are first constructed. That said, it may be desirable to change the configuration of data structures dependent on the user and/or computing system that accesses the databases. Accordingly, there is a need for a way to dynamically restructure data elements and structures within databases.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

The present disclosure is directed to a system for restructuring electronic data elements within a mutable hierarchical database. In particular, the system may dynamically perform perspective-based restructuring the database depending on the status and/or identity of the user or computing system that is accessing the database. In this regard, the system may use an artificial intelligence and/or machine learning application to progressively modify relationships and/or attributes of data elements within the database to create multiple configurations or arrangements of database structures along certain perspectives and/or dimensions. Once the multiple configurations are generated, the system may allow the data structures to be dynamically adjusted based on the perspective or purpose for which the database is accessed.

According, embodiments of the present disclosure provide a system for restructuring electronic data elements within a mutable hierarchical database. The system may comprise a memory device with computer-readable program code stored thereon; a communication device; and a processing device operatively coupled to the memory device and the communication device. The processing device may be configured to execute the computer-readable program code to generate the mutable hierarchical database, wherein the mutable hierarchical database comprises one or more data elements; receive a first request to access the mutable hierarchical database; based on the first request, create a first configuration of the data elements within the mutable hierarchical database; receive a second request to access the mutable hierarchical database; and based on the second request, create a second configuration of the data elements within the mutable hierarchical database.

In some embodiments, the one or more data elements comprise nodes, edges, and properties, wherein creating the first configuration of the data elements and creating the second configuration of the data elements comprises at least one of adding nodes, removing nodes, modifying relationships, modifying properties, or changing hierarchical positions of nodes.

In some embodiments, the first request is associated with a first objective and submitted by a first user, wherein the first configuration of the data elements is associated with the first objective, wherein the second request is associated with a second objective and submitted by a second user, wherein the second configuration of the data elements is associated with the second objective.

In some embodiments, the computer-readable program code further causes the processing device to present the first configuration of the data elements to the first user; and present the second configuration of the data elements to the second user.

In some embodiments, the first request is associated with a first objective and submitted by a first user, wherein the first configuration of the data elements is associated with the first objective, wherein the second request is associated with a second objective and submitted by the first user, wherein the second configuration of the data elements is associated with the second objective.

In some embodiments, the computer-readable program code further causes the processing device to present the first configuration of the data elements and the second configuration of the data elements to the first user.

In some embodiments, the computer-readable program code further causes the processing device to store the first configuration of the data elements and the second configuration of the data elements within a configuration repository.

Embodiments of the present disclosure also provide a computer program product for restructuring electronic data elements within a mutable hierarchical database. The computer program product may comprise at least one non-transitory computer readable medium having computer-readable program code portions embodied therein, the computer-readable program code portions comprising executable code portions for generating the mutable hierarchical database, wherein the mutable hierarchical database comprises one or more data elements; receiving a first request to access the mutable hierarchical database; based on the first request, creating a first configuration of the data elements within the mutable hierarchical database; receiving a second request to access the mutable hierarchical database; and based on the second request, creating a second configuration of the data elements within the mutable hierarchical database.

In some embodiments, the one or more data elements comprise nodes, edges, and properties, wherein creating the first configuration of the data elements and creating the second configuration of the data elements comprises at least one of adding nodes, removing nodes, modifying relationships, modifying properties, or changing hierarchical positions of nodes.

In some embodiments, the first request is associated with a first objective and submitted by a first user, wherein the first configuration of the data elements is associated with the first objective, wherein the second request is associated with a second objective and submitted by a second user, wherein the second configuration of the data elements is associated with the second objective.

In some embodiments, the computer-readable program code portions further comprise executable code portions for presenting the first configuration of the data elements to the first user; and presenting the second configuration of the data elements to the second user.

In some embodiments, the first request is associated with a first objective and submitted by a first user, wherein the first configuration of the data elements is associated with the first objective, wherein the second request is associated with a second objective and submitted by the first user, wherein the second configuration of the data elements is associated with the second objective.

In some embodiments, the computer-readable program code portions further comprise executable code portions for presenting the first configuration of the data elements and the second configuration of the data elements to the first user.

Embodiments of the present disclosure also provide a computer-implemented method for restructuring electronic data elements within a mutable hierarchical database. The method may comprise generating the mutable hierarchical database, wherein the mutable hierarchical database comprises one or more data elements; receiving a first request to access the mutable hierarchical database; based on the first request, creating a first configuration of the data elements within the mutable hierarchical database; receiving a second request to access the mutable hierarchical database; and based on the second request, creating a second configuration of the data elements within the mutable hierarchical database.

In some embodiments, the one or more data elements comprise nodes, edges, and properties, wherein creating the first configuration of the data elements and creating the second configuration of the data elements comprises at least one of adding nodes, removing nodes, modifying relationships, modifying properties, or changing hierarchical positions of nodes.

In some embodiments, the first request is associated with a first objective and submitted by a first user, wherein the first configuration of the data elements is associated with the first objective, wherein the second request is associated with a second objective and submitted by a second user, wherein the second configuration of the data elements is associated with the second objective.

In some embodiments, the method further comprises presenting the first configuration of the data elements to the first user; and presenting the second configuration of the data elements to the second user.

In some embodiments, the first request is associated with a first objective and submitted by a first user, wherein the first configuration of the data elements is associated with the first objective, wherein the second request is associated with a second objective and submitted by the first user, wherein the second configuration of the data elements is associated with the second objective.

In some embodiments, the method further comprises presenting the first configuration of the data elements and the second configuration of the data elements to the first user.

In some embodiments, the method further comprises storing the first configuration of the data elements and the second configuration of the data elements within a configuration repository.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 illustrates an operating environment for the mutable database system, in accordance with one embodiment of the present disclosure;

FIG. 2A illustrates a set of data elements within a first configuration of the mutable hierarchical database, in accordance with one embodiment of the present disclosure;

FIG. 2B illustrates the set of data elements within a second configuration of the mutable hierarchical database, in accordance with one embodiment of the present disclosure; and

FIG. 3 illustrates a process flow for the mutable database system, in accordance with one embodiment of the present disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

“Entity” as used herein may refer to an individual or an organization that owns and/or operates an online system of networked computing devices, systems, and/or peripheral devices on which the system described herein is implemented. The entity may be a business organization, a non-profit organization, a government organization, and the like, which may routinely use various types of applications within its enterprise environment to accomplish its organizational objectives.

“Entity system” as used herein may refer to the computing systems, devices, software, applications, communications hardware, and/or other resources used by the entity to perform the functions as described herein. Accordingly, the entity system may comprise desktop computers, laptop computers, servers, Internet-of-Things (“IoT”) devices, networked terminals, mobile smartphones, smart devices (e.g., smart watches), network connections, and/or other types of computing systems or devices and/or peripherals along with their associated applications.

“Computing system” or “computing device” as used herein may refer to a networked computing device within the entity system. The computing system may include a processor, a non-transitory storage medium, a communications device, and a display. The computing system may be configured to support user logins and inputs from any combination of similar or disparate devices. Accordingly, the computing system may be a portable electronic device such as a smartphone, tablet, single board computer, smart device, or laptop. In other embodiments, the computing system may be a stationary unit such as a personal desktop computer, networked terminal, IoT device, or the like.

“User” as used herein may refer to an individual who may interact with the entity system to access the functions therein. Accordingly, the user may be an agent, employee, associate, contractor, or other authorized party who may access, use, administrate, maintain, and/or manage the computing systems within the entity system. In other embodiments, the user may be a client or customer of the entity.

Accordingly, as used herein the term “user device” or “mobile device” may refer to mobile phones, personal computing devices, tablet computers, wearable devices, and/or any stationary or portable electronic device capable of receiving and/or storing data therein.

“Neural network” as referred to herein may refer to a network of computing nodes that use artificial intelligence and/or machine learning algorithms to accomplish certain tasks. Broadly, neural networks may be used for tasks requiring pattern recognition. For instance, a neural network may be constructed and used for the purposes of speech recognition, facial recognition, fraud detection, machine translation, gaming AI, or the like.

“Node” or “vertex” as used herein may refer to a functional data unit within a graph database, where the vertices may be connected to one another via “edges” or “lines” which establish certain defined relationships between vertices. For instance, a node labeled “server” may be connected to a node named “client” via an edge indicating that the server is configured to communicatively provide a resource (e.g., data) to the client. In some embodiments, the nodes and/or the edges may be associated with one or more “properties” which further add descriptive information to the nodes and/or edges.

Embodiments of the present disclosure provide a system for restructuring electronic data elements within a mutable hierarchical database. A database, which in some embodiments may be a hierarchical graph database, may contain one or more data entries (e.g., nodes) which have one or more defined attributes (e.g., properties). Each of the one or more data entries may be connected to other data entries by relationships, where the relationships indicate that the data entries are related along a defined dimension (e.g., hierarchical relationships such as “parent-child”). In this regard, properties may further be assigned to relationships to add further dimensions to each relationship.

In generating such a database, the system (which may be referred to herein as the “mutable database system”) may be used to provide an initial structure or configuration for data entries (e.g., nodes, properties, relationships between nodes, or the like) from an initial viewpoint (e.g., a perspective of an initial user, dimension, use case, or the like). Within the initial structure, the data entries may be arranged into a hierarchical structure with certain nodes being on higher and/or lower levels within the hierarchy. Certain nodes may further have cross-level relationships (e.g., parent, child, or the like) with other nodes.

After generating the initial structure, the system may, via AI/machine learning models, add properties to certain data elements (e.g., nodes, relationships, or other properties). The added properties may identify the configuration or position of the data elements when the database is viewed from a different perspective or dimension from the perspective or dimension from which the database was initially viewed during the construction of the initial structure of the database. In this way, said added properties may cause the data elements to be restructured depending on the perspective from which the database is viewed or accessed. For example, certain data elements, when viewed from a different perspective, may be placed higher or lower in the hierarchy, may be related to different data elements, or may be present or absent in the structure entirely, depending on who is accessing the database, the purpose for accessing the database, and/or what type of data records are queried, or the like. In this way, a second configuration of data elements may be created which may be specific to the environment and/or circumstances in which the database is accessed. The process as described above may be iterated to generate additional configurations of data elements (e.g., a third configuration, fourth configuration, or the like) to account for various additional perspectives or conditions in which the database may be accessed. In some embodiments, at least a portion of each configuration may be saved in a saved state. In other embodiments, the database may be dynamically reconfigured for each query or access request. By generating various structures or configurations of the data elements within the database, the system may generate a fluid, mutable database which may dynamically present the data entries within the database in different ways depending on the context in which the database is accessed.

An exemplary use case is provided below for illustrative purposes. In one embodiment, an entity may maintain a database of computing capabilities related to data security. In such an embodiment, the database may contain various data entries for capabilities as well as their relationships to other capabilities. For instance, an initial configuration of the database may include a data entry may be made for a child node which represents root kit identification, where a parent node (e.g., an ability to detect malicious files or other threat vectors) may be added in reference to the child node. In some embodiments, such a relationship may be tagged with additional properties to identify the significance of the relationship along certain vectors (e.g., data discovery vector). Once the initial configuration is completed, the data entries may be reconfigured to account for different access scenarios. For example, if the database is subsequently viewed from a systems stability viewpoint rather than a data security viewpoint, certain nodes may be rearranged hierarchically in relation to other nodes, relationships may be altered, existing nodes may be exclude, and new nodes may be included (e.g., authentication credential requirements may be more relevant to data security rather than systems stability). In such a manner, the system may generate multiple different configurations of the same database which may be optimally suited for the user or the purpose for which the database is accessed.

The system as described herein confers a number of technological advantages over conventional database systems. By introducing mutability of data elements within the database, the system may dynamically provide the most relevant data in response to viewpoint-dependent access requests and/or queries. Furthermore, rearranging data elements may allow the data elements within the database to be traversed with a much greater computing efficiency, thereby saving valuable system resources.

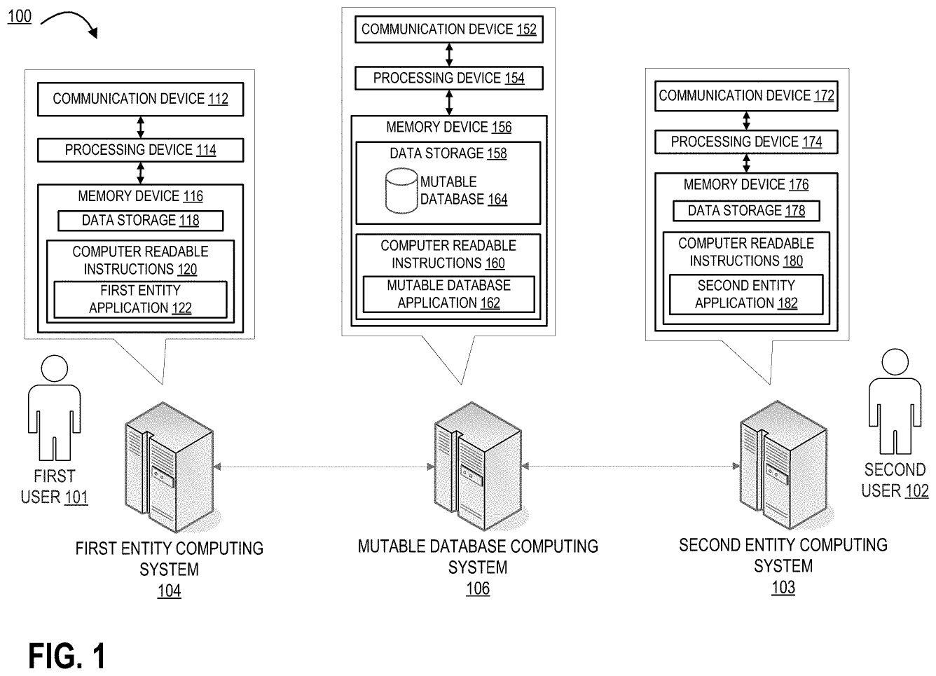

Turning now to the figures, FIG. 1 illustrates an operating environment 100 for the mutable database system, in accordance with one embodiment of the present disclosure. In particular, FIG. 1 illustrates a mutable database computing system 106 that is operatively coupled, via a network, to a first entity computing system 104 and/or an second entity computing system 103. In such a configuration, the mutable database computing system 106 may transmit information to and receive information from the first entity computing system 104 and/or the second entity computing system 103. It should be understood that FIG. 1 illustrates only an exemplary embodiment of the operating environment 100, and it will be appreciated that one or more functions of the systems, devices, or servers as depicted in FIG. 1 may be combined into a single system, device, or server. For instance, the functions of the first entity computing system 104 and the second entity computing system 103 may be executed on a single computing system. Furthermore, a single system, device, or server as depicted in FIG. 1 may represent multiple systems, devices, or servers. For instance, the mutable database computing system 106 may represent multiple mutable database computing systems 106 which host a distributed database.

The network may be a system specific distributive network receiving and distributing specific network feeds and identifying specific network associated triggers. The network include one or more cellular radio towers, antennae, cell sites, base stations, telephone networks, cloud networks, radio access networks (RAN), WiFi networks, or the like. Additionally, the network may also include a global area network (GAN), such as the Internet, a wide area network (WAN), a local area network (LAN), or any other type of network or combination of networks. Accordingly, the network may provide for wireline, wireless, or a combination wireline and wireless communication between devices on the network.

As illustrated in FIG. 1, the mutable database computing system 106 may comprise a communication device 152, a processing device 154, and a memory device 156. The mutable database computing system 106 may be owned and/or operated by an entity such as an Internet service provider, financial institution, business organization, government agency, or the like. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 154 is operatively coupled to the communication device 152 and the memory device 156. The processing device 154 uses the communication device 152 to communicate with the network and other devices on the network, such as, but not limited to the first entity computing system 104 and/or the second entity computing system 103. The communication device 152 generally comprises a modem, antennae, WiFi or Ethernet adapter, radio transceiver, or other device for communicating with other devices on the network.

The memory device 156 may have computer-readable instructions 160 stored thereon, which in one embodiment includes the computer-readable instructions 160 of a mutable database application 162 which allows the entity system to perform the database restructuring functions as described herein. In some embodiments, the memory device 156 includes data storage 158 for storing data related to the system environment. In this regard, the data storage 158 may comprise a mutable database 164, which may include various types of data used by the entity. For instance, the mutable database 164 may comprise data entries relating to certain computing capabilities (e.g., detection of malicious code) and the relationships of the capabilities with one another. Accordingly, in some embodiments, the mutable database 164 may comprise a graph database in which the capabilities are stored as vertices and the associated relationships are stored as edges.

The mutable database application 162 may comprise computer-executable program code which may instruct the processing device 154 to perform certain logic, data processing, and data storing functions of the application to accomplish the entity's objectives. For instance, the mutable database application 162 may receive input data and, based on the input data, modify the configuration (e.g., data elements, data structures, relationships, or the like) of the mutable database 164 based on the input data. In particular, the mutable database application 162 may detect the identity of users and/or computing systems accessing the mutable database and/or the nature of the query or access request in order to make configuration changes to the mutable database 164. In some embodiments, the mutable database application 162 may use artificial intelligence and/or neural networks to determine the optimal configuration of the mutable database 164 over a period of time via an iterative process. In such embodiments, the mutable database computing system may further comprise a neural network device which may include a hardware, software, or part hardware and software implementation of a neural network. Accordingly, the neural network may be a multilayer perceptron, Boltzmann machine, Markov chain, long/short term memory (LSTM), recurrent neural network (RNN), or the like.

As further illustrated in FIG. 1, the first entity computing system 104 may be a computing system which is owned and/or operated by the entity for executing various processes to achieve the entity's objectives. In this regard, the first entity computing system 104 may be, for example, a networked terminal, server, desktop computer, or the like, though it is within the scope of the disclosure for the first entity computing system 104 to be a portable device such as a cellular phone, smart phone, smart device, personal data assistant (PDA), laptop, or the like, which may be operated by a first user 101. The first entity computing system 104 generally comprises a communication device 112, a processing device 114, and a memory device 116, where the processing device 114 is operatively coupled to the communication device 112 and the memory device 116. The processing device 114 uses the communication device 112 to communicate with the network and other devices on the network, such as, but not limited to the mutable database computing system 106 and/or the second entity computing system 103. As such, the communication device 112 generally comprises a modem, antennae, WiFi or Ethernet adapter, radio transceiver, or other device for communicating with other devices on the network.

The first entity computing system 104 comprises computer-readable instructions 120 and data storage 118 stored in the memory device 116, which in one embodiment includes the computer-readable instructions 120 of a first entity application 122. The first entity application 122 may comprise executable code portions for performing functions related to the various processes executed for the entity's purposes and objectives. In particular, the first user 101 may use the first entity computing system to access the mutable database 164 stored on the mutable database computing system 164. The mutable database computing system 164 may arrange the data elements within the mutable database 164 based on information such as the identity of the first user 101 and/or the first entity computing system 104, the nature of the access request or query, metadata regarding the first user 101 (e.g., occupation, role within the entity, or the like). In some embodiments, the mutable database 164 may be structured into an initial configuration based on inputs from the first user 101.

The operating environment 100 may further comprise a second entity computing system 103. The second entity computing system 103 may refer to a second computing system which may be owned and/or operated by the entity to perform various functions related to the entity's objectives. In this regard, the second entity computing system 103 may be operated by a second user 102 such as an employee of the entity. Accordingly, the second entity computing system 103 may also comprise a processing device 174 operatively coupled to the communication device 172 and a memory device 176 comprising data storage 178 and computer readable instructions 180.

The computer readable instructions 180 may comprise a second entity application 182 which may be configured to instruct the processing device 174 to execute certain functions over the network, such as interacting with the mutable database computing system 106, application computing system 105, and/or the first entity computing system 104. In particular, the second entity application 182 may be used by the second user 102 to access the mutable database 164 within the mutable database computing system 106. Based on the interactions of the mutable database computing system 106 with the second entity computing system 103, the configuration of the mutable database 164 may be altered based on the identity of the second user and/or the second entity computing system 103, the nature of the query of the second user 102, metadata associated with the second user 102, or the like. In this way, the system may provide a first configuration of the mutable database 164 to the first user 101, while providing a second configuration of the mutable database 164 to the second user 102.

The communication device 172, and other communication devices as described herein, may comprise a wireless local area network (WLAN) such as WiFi based on the Institute of Electrical and Electronics Engineers' (IEEE) 802.11 standards, Bluetooth short-wavelength UHF radio waves in the ISM band from 2.4 to 2.485 GHz or other wireless access technology. Alternatively or in addition to the wireless interface, the second entity computing system 103 may also include a communication interface device that may be connected by a hardwire connection to the resource distribution device. The interface device may comprise a connector such as a USB, SATA, PATA, SAS or other data connector for transmitting data to and from the respective computing system.

The computing systems described herein may each further include a processing device communicably coupled to devices as a memory device, output devices, input devices, a network interface, a power source, a clock or other timer, a camera, a positioning system device, a gyroscopic device, one or more chips, and the like.

In some embodiments, the computing systems may access one or more databases or datastores (not shown) to search for and/or retrieve information related to the service provided by the entity. The computing systems may also access a memory and/or datastore local to the various computing systems within the operating environment 100.

The processing devices as described herein may include functionality to operate one or more software programs or applications, which may be stored in the memory device. For example, a processing device may be capable of operating a connectivity program, such as a web browser application. In this way, the computing systems may transmit and receive web content, such as, for example, product valuation, service agreements, location-based content, and/or other web page content, according to a Wireless Application Protocol (WAP), Hypertext Transfer Protocol (HTTP), and/or the like.

A processing device may also be capable of operating applications. The applications may be downloaded from a server and stored in the memory device of the computing systems. Alternatively, the applications may be pre-installed and stored in a memory in a chip.

The chip may include the necessary circuitry to provide integration within the devices depicted herein. Generally, the chip will include data storage which may include data associated with the service that the computing systems may be communicably associated therewith. The chip and/or data storage may be an integrated circuit, a microprocessor, a system-on-a-chip, a microcontroller, or the like. In this way, the chip may include data storage. Of note, it will be apparent to those skilled in the art that the chip functionality may be incorporated within other elements in the devices. For instance, the functionality of the chip may be incorporated within the memory device and/or the processing device. In a particular embodiment, the functionality of the chip is incorporated in an element within the devices. Still further, the chip functionality may be included in a removable storage device such as an SD card or the like.

A processing device may be configured to use the network interface to communicate with one or more other devices on a network. In this regard, the network interface may include an antenna operatively coupled to a transmitter and a receiver (together a “transceiver”). The processing device may be configured to provide signals to and receive signals from the transmitter and receiver, respectively. The signals may include signaling information in accordance with the air interface standard of the applicable cellular system of the wireless telephone network that may be part of the network. In this regard, the computing systems may be configured to operate with one or more air interface standards, communication protocols, modulation types, and access types. By way of illustration, the devices may be configured to operate in accordance with any of a number of first, second, third, fourth, and/or fifth-generation communication protocols and/or the like. For example, the computing systems may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, with fifth-generation (5G) wireless communication protocols, or the like. The devices may also be configured to operate in accordance with non-cellular communication mechanisms, such as via a wireless local area network (WLAN) or other communication/data networks.

The network interface may also include an application interface in order to allow a user or service provider to execute some or all of the above-described processes. The application interface may have access to the hardware, e.g., the transceiver, and software previously described with respect to the network interface. Furthermore, the application interface may have the ability to connect to and communicate with an external data storage on a separate system within the network.

The devices may have an interface that includes user output devices and/or input devices. The output devices may include a display (e.g., a liquid crystal display (LCD) or the like) and a speaker or other audio device, which are operatively coupled to the processing device. The input devices, which may allow the devices to receive data from a second user 102, may include any of a number of devices allowing the devices to receive data from a second user 102, such as a keypad, keyboard, touch-screen, touchpad, microphone, mouse, joystick, other pointer device, button, soft key, and/or other input device(s).

The devices may further include a power source. Generally, the power source is a device that supplies electrical energy to an electrical load. In some embodiment, power source may convert a form of energy such as solar energy, chemical energy, mechanical energy, or the like to electrical energy. Generally, the power source may be a battery, such as a lithium battery, a nickel-metal hydride battery, or the like, that is used for powering various circuits, e.g., the transceiver circuit, and other devices that are used to operate the devices. Alternatively, the power source may be a power adapter that can connect a power supply from a power outlet to the devices. In such embodiments, a power adapter may be classified as a power source “in” the devices.

As described above, the computing devices as shown in FIG. 1 may also include a memory device operatively coupled to the processing device. As used herein, “memory” may include any computer readable medium configured to store data, code, or other information. The memory device may include volatile memory, such as volatile Random Access Memory (RAM) including a cache area for the temporary storage of data. The memory device may also include non-volatile memory, which can be embedded and/or may be removable. The non-volatile memory may additionally or alternatively include an electrically erasable programmable read-only memory (EEPROM), flash memory or the like.

The memory device may store any of a number of applications or programs which comprise computer-executable instructions/code executed by the processing device to implement the functions of the devices described herein.

The computing systems may further comprise a gyroscopic device. The positioning system, input device, and the gyroscopic device may be used in correlation to identify phases within a service term.

Each computing system may also have a control system for controlling the physical operation of the device. The control system may comprise one or more sensors for detecting operating conditions of the various mechanical and electrical systems that comprise the computing systems or of the environment in which the computing systems are used. The sensors may communicate with the processing device to provide feedback to the operating systems of the device. The control system may also comprise metering devices for measuring performance characteristics of the computing systems. The control system may also comprise controllers such as programmable logic controllers (PLC), proportional integral derivative controllers (PID) or other machine controllers. The computing systems may also comprise various electrical, mechanical, hydraulic or other systems that perform various functions of the computing systems. These systems may comprise, for example, electrical circuits, motors, compressors, or any system that enables functioning of the computing systems.

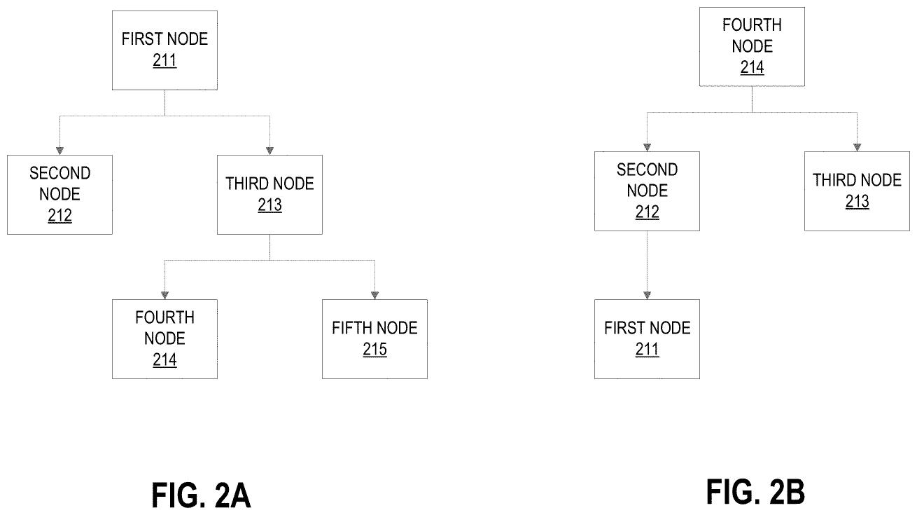

FIG. 2A illustrates a set of data elements within a first configuration of the mutable hierarchical database, in accordance with one embodiment of the present disclosure. The mutable database may contain data entries related to data security. In this regard, the mutable database may include, for instance, a first node 211 which is the parent to a second node 212 and a third node 313. The third node 313 may in turn be a parent to a fourth node 214 and a fifth node 215. The nodes may represent particular computing capabilities which are arranged in relationship to each other depending on the context in which the database is accessed. Each node and/or relationship may be further defined by properties or attributes which provide further details about the node and/or relationship. For example, this first configuration of the mutable database may relate, in an exemplary embodiment, to prevention of data breaches or compromise. In such an embodiment, the ability to detect malicious code may be the parent of a rootkit detection capability. In some embodiments, the first configuration may represent an initial configuration which is determined at the construction of the mutable database. In such embodiments, certain data elements may be persistent across all configurations of the mutable database (e.g., the first node 211 is always included in each configuration). In other embodiments, the arrangement of data elements may be fluid such that the configuration of the database may not necessarily include persistent data elements.

FIG. 2B illustrates the data elements within a second configuration of the mutable hierarchical database, in accordance with one embodiment of the present disclosure. The second configuration of the mutable database may be presented to a user when the mutable database is accessed from a different viewpoint or perspective than the viewpoint or perspective from which the mutable database was accessed in the first configuration. The second configuration may be changed, for instance, when a second user or computing system accesses the database, the database is accessed for a different purpose, or the like. For example, the second configuration may be an arrangement of computing capabilities as they relate to data integrity, which may be related to the first configuration, which is an arrangement of capabilities as they relate to data breaches or compromise. Accordingly, the second configuration may include several of the capabilities (e.g., nodes) that existed within the first configuration, but with changed relationships (e.g., two related capabilities may have different relationships depending on context, such as data integrity vs. data breach). Said changes may be made based on the properties or attributes of the nodes and/or relationships. For example, the fourth node 214 within the second configuration may be the parent of the third node 213, in contrast with the first configuration. Moreover, certain nodes may be absent from the second configuration entirely if the node is not relevant to the perspective to which the second configuration is tailored. For example, if the fifth node 215 represents a capability that is relevant to the first configuration (e.g., relates to data breaches) but is not relevant to the second configuration (e.g., relates to data integrity), the fifth node 215 may be absent from the second configuration, as depicted in FIG. 2B. In the manner described above, the process of creating multiple configurations may be repeated to provide viewpoint dependent reconfigurations of the database. In some embodiments, the reconfiguration process may be repeated each time the database is accessed, thus resulting in a potentially infinite number of configurations of the data elements within the mutable database.

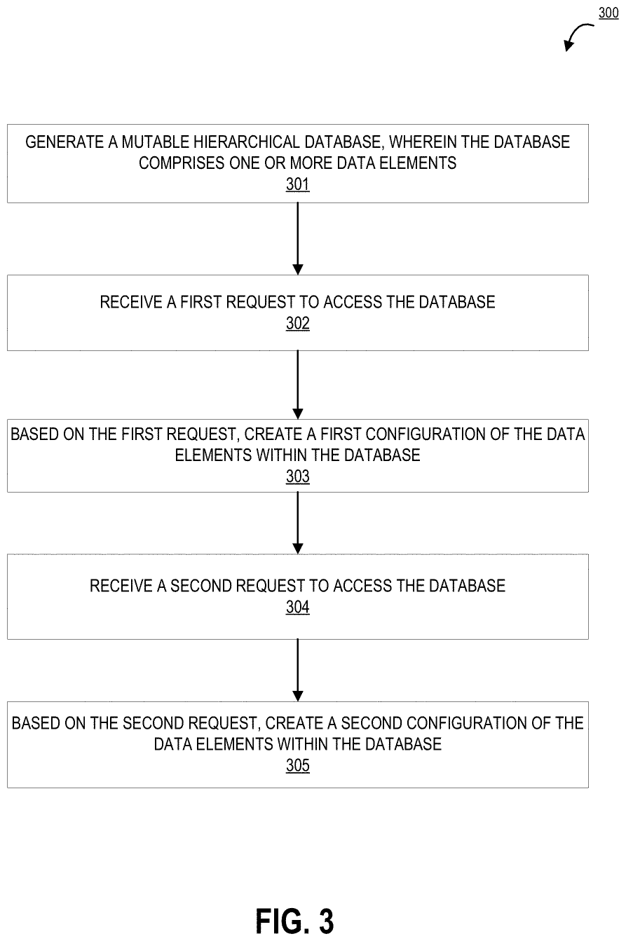

FIG. 3 illustrates a process flow 300 for the mutable database system, in accordance with some embodiments of the present disclosure. The process 300 begins at block 301, where the system generates a mutable hierarchical database, wherein the database comprises one or more data elements. The data elements may comprise various types of data structures within a database, such as data entries, nodes, edges, properties, or the like. In some embodiments, the database may be a graph database with one or more nodes being connected to other nodes via relationships, where each node and/or relationship may be further defined via properties or attributes. Accordingly, the database may further be a hierarchical database with nodes existing within levels within the database (e.g., certain nodes may be higher or lower within the hierarchy in comparison to other nodes). To illustrate, a relationship between a first node and a second node may be defined as a parent-child relationship. In such an embodiment, the first node may be on a higher level within the hierarchical database in comparison to the second node.

The process continues to block 302, where the system receives a first request to access the database. The first request may be received from a first user and/or a first computing system, where the request may comprise a query for data records within the mutable database. Said query may be further defined by a query type, or a stated objective or purpose for accessing a database. For instance, the query may include requests for data records related to or associated with a particular objective, purpose, or perspective (e.g., data security). Accordingly, the first user may be an employee of the entity who has been tasked to obtain the data records with said purpose or perspective in mind. In such embodiments, the first request may further comprise information about the first user, such as title, role, membership in a particular division or team, or the like.

The process continues to block 303, where the system creates a first configuration of the data elements within the database. The first configuration of data elements may include a particular arrangement of nodes, relationships, and/or properties based on the nature of the first request. For example, based on the information within the first request (e.g., identity of the user, query type, data elements requested, or the like), the system may arrange certain nodes into specific positions and/or orientations within a hierarchy. Some nodes may be placed higher or lower in relation to other nodes, and nodes may be connected to one another via relationships within and across levels within the hierarchy. Continuing the above example, if the first request comprises a query for data records relating to data security, the first configuration may reflect an arrangement of data elements which is tailored to the perspective of data security. Once the first configuration has been generated, the system may present the first configuration (e.g., a copy of data elements and respective relationships) to the first user.

The process continues to block 304, where the system receives a second request to access the database. The second request may include a query for data records from a different perspective in comparison to the first request. Accordingly, the second request may be received from a second user and/or second computing system. That said, it is within the scope of the disclosure for a second request to be submitted by the same user (e.g., the first user). For example, the second request may comprise a query for data records relating to data integrity (in contrast to the first request, which may comprise a query for data records relating to data security).

The process concludes at block 305, where the system, based on the second request, creates a second configuration of the data elements within the database. The system may rearrange the data elements to be optimally suitable for responding to the second request. For instance, the data elements may be modified based on the identity of the user who submitted the second request, the query type, purpose for which the database is accessed, or the like. Continuing the above example, if the second request is submitted from the perspective of data integrity, the database may be rearranged such that the data elements may be configured to suit the perspective of data integrity. Accordingly, the system may execute one or more operations to rearrange the data elements, including adding new nodes, excluding existing nodes, modifying relationships (e.g., changing the direction of the relationships, unlinking or linking certain nodes, or the like), adjusting the position of the nodes within the hierarchical structure, or the like. Once the system has generated the second configuration, the system may present the second configuration of data elements to the user who submitted the second request (e.g., the first user or the second user). The system may repeat the process as described above to generate additional configurations (e.g., a third configuration, a fourth configuration, and the like) to account for additional perspectives from which the database is accessed. Accordingly, in some embodiments, the system may store the various configurations of the database in a configuration repository such that the appropriate configuration may be recalled based on the query. In other embodiments, the system may, rather than storing the configurations, generate each configuration at run time for each query received (e.g., the database is reconstructed each time the database is queried). In this way, the system may create a fluid database which adapts to the various organizational needs of the entity.

Each communication interface described herein generally includes hardware, and, in some instances, software, that enables the computer system, to transport, send, receive, and/or otherwise communicate information to and/or from the communication interface of one or more other systems on the network. For example, the communication interface of the user input system may include a wireless transceiver, modem, server, electrical connection, and/or other electronic device that operatively connects the user input system to another system. The wireless transceiver may include a radio circuit to enable wireless transmission and reception of information.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EEPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for restructuring electronic data elements within a mutable hierarchical database, the system comprising:
a memory device with computer-readable program code stored thereon;
a communication device; and
a processing device operatively coupled to the memory device and the communication device, wherein the processing device is configured to execute the computer-readable program code to:
generate the mutable hierarchical database, wherein the mutable hierarchical database comprises one or more data elements;
receive a first request to access the mutable hierarchical database;
based on the first request, create a first configuration of the data elements within the mutable hierarchical database;
receive a second request to access the mutable hierarchical database; and
based on the second request, create a second configuration of the data elements within the mutable hierarchical database.

2. The system according to claim 1, wherein the one or more data elements comprise nodes, edges, and properties, wherein creating the first configuration of the data elements and creating the second configuration of the data elements comprises at least one of adding nodes, removing nodes, modifying relationships, modifying properties, or changing hierarchical positions of nodes.

3. The system according to claim 1, wherein the first request is associated with a first objective and submitted by a first user, wherein the first configuration of the data elements is associated with the first objective, wherein the second request is associated with a second objective and submitted by a second user, wherein the second configuration of the data elements is associated with the second objective.

4. The system according to claim 3, wherein the computer-readable program code further causes the processing device to:
present the first configuration of the data elements to the first user; and
present the second configuration of the data elements to the second user.

5. The system according to claim 1, wherein the first request is associated with a first objective and submitted by a first user, wherein the first configuration of the data elements is associated with the first objective, wherein the second request is associated with a second objective and submitted by the first user, wherein the second configuration of the data elements is associated with the second objective.

6. The system according to claim 5, wherein the computer-readable program code further causes the processing device to present the first configuration of the data elements and the second configuration of the data elements to the first user.

7. The system according to claim 1, wherein the computer-readable program code further causes the processing device to store the first configuration of the data elements and the second configuration of the data elements within a configuration repository.

8. A computer program product for restructuring electronic data elements within a mutable hierarchical database, the computer program product comprising at least one non-transitory computer readable medium having computer-readable program code portions embodied therein, the computer-readable program code portions comprising executable code portions for:
generating the mutable hierarchical database, wherein the mutable hierarchical database comprises one or more data elements;
receiving a first request to access the mutable hierarchical database;
based on the first request, creating a first configuration of the data elements within the mutable hierarchical database;
receiving a second request to access the mutable hierarchical database; and
based on the second request, creating a second configuration of the data elements within the mutable hierarchical database.

9. The computer program product according to claim 8, wherein the one or more data elements comprise nodes, edges, and properties, wherein creating the first configuration of the data elements and creating the second configuration of the data elements comprises at least one of adding nodes, removing nodes, modifying relationships, modifying properties, or changing hierarchical positions of nodes.

10. The computer program product according to claim 8, wherein the first request is associated with a first objective and submitted by a first user, wherein the first configuration of the data elements is associated with the first objective, wherein the second request is associated with a second objective and submitted by a second user, wherein the second configuration of the data elements is associated with the second objective.

11. The computer program product according to claim 10, wherein the computer-readable program code portions further comprise executable code portions for:
presenting the first configuration of the data elements to the first user; and
presenting the second configuration of the data elements to the second user.

12. The computer program product according to claim 8, wherein the first request is associated with a first objective and submitted by a first user, wherein the first configuration of the data elements is associated with the first objective, wherein the second request is associated with a second objective and submitted by the first user, wherein the second configuration of the data elements is associated with the second objective.

13. The computer program product according to claim 12, wherein the computer-readable program code portions further comprise executable code portions for presenting the first configuration of the data elements and the second configuration of the data elements to the first user.

14. A computer-implemented method for restructuring electronic data elements within a mutable hierarchical database, wherein the method comprises:
generating the mutable hierarchical database, wherein the mutable hierarchical database comprises one or more data elements;
receiving a first request to access the mutable hierarchical database;
based on the first request, creating a first configuration of the data elements within the mutable hierarchical database;
receiving a second request to access the mutable hierarchical database; and
based on the second request, creating a second configuration of the data elements within the mutable hierarchical database.

15. The computer-implemented method according to claim 14, wherein the one or more data elements comprise nodes, edges, and properties, wherein creating the first configuration of the data elements and creating the second configuration of the data elements comprises at least one of adding nodes, removing nodes, modifying relationships, modifying properties, or changing hierarchical positions of nodes.

16. The computer-implemented method according to claim 14, wherein the first request is associated with a first objective and submitted by a first user, wherein the first configuration of the data elements is associated with the first objective, wherein the second request is associated with a second objective and submitted by a second user, wherein the second configuration of the data elements is associated with the second objective.

17. The computer-implemented method according to claim 16, the method further comprising:
presenting the first configuration of the data elements to the first user; and
presenting the second configuration of the data elements to the second user.

18. The computer-implemented method according to claim 14, wherein the first request is associated with a first objective and submitted by a first user, wherein the first configuration of the data elements is associated with the first objective, wherein the second request is associated with a second objective and submitted by the first user, wherein the second configuration of the data elements is associated with the second objective.

19. The computer-implemented method according to claim 18, the method further comprising presenting the first configuration of the data elements and the second configuration of the data elements to the first user.

20. The computer-implemented method according to claim 14, the method further comprising storing the first configuration of the data elements and the second configuration of the data elements within a configuration repository.
